(19) United States
(12) Patent Application Publication
(10) Pub. No.: US 2017/0061209 A1
(43) Pub. Date: Mar. 2, 2017

(54) OBJECT PROCESSING METHOD, REFERENCE IMAGE GENERATING METHOD, REFERENCE IMAGE GENERATING APPARATUS, OBJECT PROCESSING APPARATUS, AND RECORDING MEDIUM

(71) Applicant: CANON KABUSHIKI KAISHA, Tokyo (JP)

(72) Inventor: Kei Watanabe, Tokyo (JP)

(21) Appl. No.: 15/239,693

(22) Filed: Aug. 17, 2016

(30) Foreign Application Priority Data
Aug. 25, 2015 (JP) 2015-165595

(51) Int. Cl. G06K 9/00; G06K 9/46

(52) U.S. Cl. CPC G06K 9/00536; G06K 9/4604

(57) ABSTRACT

A robot arm and a light are capable of varying and setting an image capturing condition of an object. A computer captures an image of the object with a camera in a state in which image capturing conditions of multiple kinds are set for the object by controlling the robot arm and the light in an image capturing process to acquire many original images corresponding to the respective image capturing conditions. The computer performs image processing on the original images corresponding to the respective image capturing conditions acquired in the image capturing process to generate reference images corresponding to the respective image capturing conditions.

### BACKGROUND OF THE INVENTION

Field of the Invention

The present invention relates to an object processing method, a reference image generating method, a reference image generating apparatus, an object processing apparatus, a program, and a recording medium, which perform pattern matching using a reference image.

Description of the Related Art

Processing apparatuses, such as robot apparatuses, have been put into practical use. The processing apparatuses perform the pattern matching of work images acquired through image capturing of works (objects) with cameras using reference images (templates) to perform recognition, positioning, measurement, and so on of the works.

Processing apparatuses in related art acquire original images through image capturing of actual works held in the processing apparatuses with cameras used in capturing of work images and perform image processing on the acquired original images to generate the reference images.

In the processing apparatuses in the related art, if the colors or the lighting states of the works to be processed are varied, the matching scores in the pattern matching of the acquired work images using the reference images may be decreased.

Accordingly, in Japanese Patent Laid-Open No. 10-213420, image processing in which multiple color effects and variation in the lighting direction are added to the original image of the work image is performed to acquire the original images corresponding to the respective image capturing conditions and the original images corresponding to the respective image capturing conditions are subjected to the image processing to generate the reference images corresponding to the respective image capturing conditions. The processing apparatus stores the reference images corresponding to the respective image capturing conditions and selects one reference image from the reference images corresponding to the respective image capturing conditions to perform the pattern matching using the selected reference image.

When the difference in the image capturing condition is artificially added to the original image in the image processing, the actual difference in the image capturing condition in the actual work may not be represented well and the matching accuracy of the pattern matching may be degraded in the reference image generated from such an original image. In order to resolve such an issue, a method is proposed in which an image of an actual work is captured while the image capturing condition is being gradually varied to acquire the original images corresponding to the respective image capturing conditions and the original images corresponding to the respective image capturing conditions are subjected to the image processing to generate the reference images corresponding to the respective image capturing conditions. A method is proposed in which many original images are acquired while the color and the lighting state of the work are being gradually varied and the many original images are subjected to the image processing to generate many reference images.

However, it is not easy to acquire the many original images while the color and the lighting state of the work are being gradually varied in the processing apparatus. In addition, during acquisition of the original image by capturing an image of the work, a downtime occurs in the processing apparatus.

The present invention provides an object processing method, a reference image generating method, a reference image generating apparatus, an object processing apparatus, a program, and a recording medium, which are capable of ensuring high accuracy of the pattern matching in a processing apparatus without causing a downtime in the processing apparatus.

### SUMMARY OF THE INVENTION

According to an embodiment, an image processing method includes generating a plurality of reference images by capturing an image of an object with a first camera to acquire an original image and performing image processing on the acquired original image in a reference image generating apparatus including the first camera; selecting a reference image used in an object processing apparatus from the plurality of reference images by capturing an image of the object with a second camera to acquire an object image and performing pattern matching between the acquired object image and the plurality of reference images that are generated in the object processing apparatus including the second camera; and performing the pattern matching between the reference image selected in the object processing apparatus and the acquired object image.

According to an embodiment, a reference image generating method of generating a reference image to be subjected to pattern matching with an object image acquired by capturing an image of an object with a second camera different from a first camera using a reference image generating apparatus including the first camera and a control unit includes capturing an image of the object with the first camera to acquire an original image by the control unit; and generating a plurality of reference images by performing image processing of the acquired original image by the control unit.

Further features of the present invention will become apparent from the following description of exemplary embodiments with reference to the attached drawings.

According to the present invention, the reference images are generated in the reference image generating apparatus including the first camera, which is different form the work (object) processing apparatus including the second camera. Accordingly, it is possible to generate the reference images capable of ensuring high accuracy of the pattern matching in the work (object) processing apparatus without causing a downtime in the work (object) processing apparatus.

### BRIEF DESCRIPTION OF THE DRAWINGS

FIG. 1 is an exemplary functional block diagram of a processing apparatus according to a first embodiment.

FIG. 2 is a block diagram illustrating an exemplary hardware configuration of the processing apparatus.

FIG. 3 is a flowchart illustrating an exemplary process of selecting a reference image in the processing apparatus.

FIGS. 4A and 4B are diagrams for describing a method of extracting an edge from image data.

FIG. 5 is a flowchart illustrating an exemplary process of measuring and inspecting a work in the processing apparatus.

FIG. 6 is an exemplary functional block diagram of a reference image generating apparatus.

FIG. 7 is a block diagram illustrating an exemplary hardware configuration of the reference image generating apparatus.

FIG. 8 is a flowchart illustrating an exemplary process of capturing an original image.

FIG. 9 is a flowchart illustrating an exemplary process of selecting a feature value.

FIGS. 10A to 10C are diagrams for describing sets of reference images.

FIGS. 11A to 11D are diagrams for describing scales of the reference image.

FIG. 12 is a flowchart illustrating an exemplary process of generating the reference image.

### DESCRIPTION OF THE EMBODIMENTS

Embodiments of the present invention will herein be described with reference to the attached drawings.

### First Embodiment

### Processing Apparatus

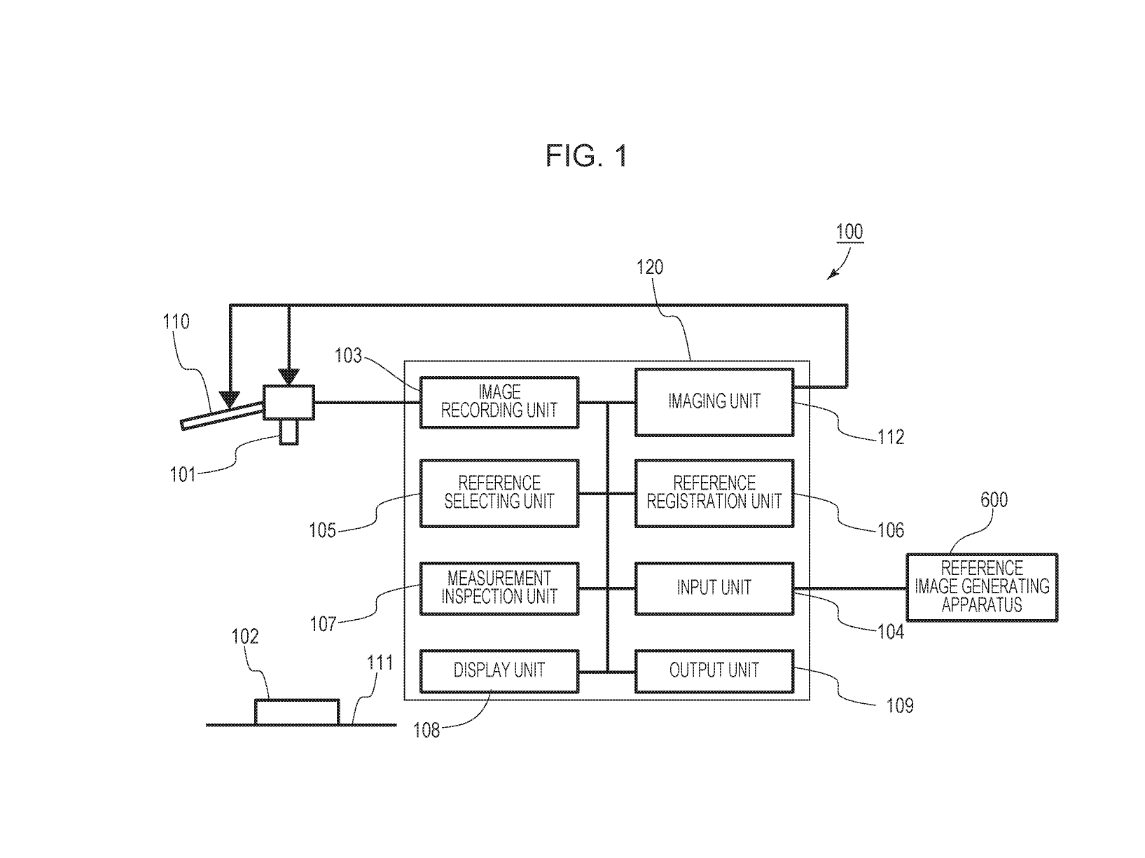

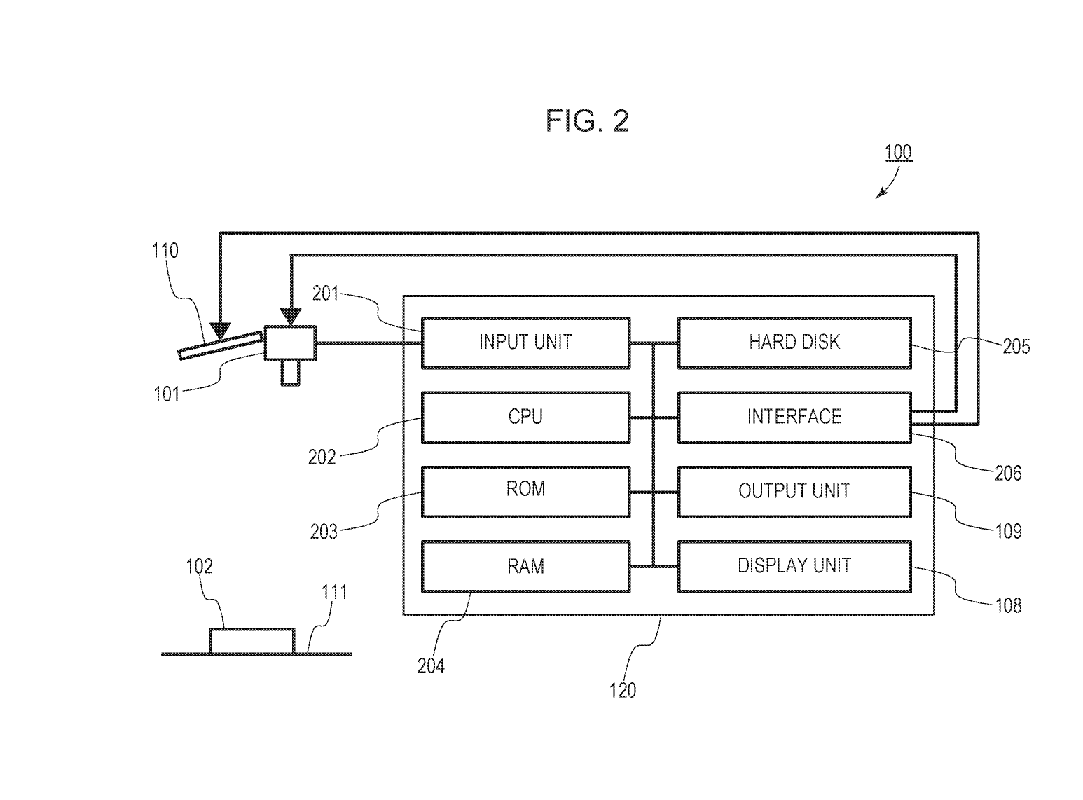

FIG. 1 is an exemplary functional block diagram of a processing apparatus according to a first embodiment. FIG. 2 is a block diagram illustrating an exemplary hardware configuration of the processing apparatus. Referring to FIG. 1, functions including an image recording unit 103, a reference selecting unit 105, a reference registration unit 106, and a measurement inspection unit 107 are realized as programs executed by a computer 120.

As illustrated in FIG. 1, a processing apparatus 100 measures and inspects a work 102, which is an object, mounted on a table 111. A camera 101 captures an image of a range including the work 102 on the table 111. The work 102 is illuminated with a light 110.

An imaging unit 112 controls the camera 101 and the light 110 to capture an image of the work 102. Image data about a work image acquired through image capturing of the work 102 with the camera 101 is stored in the image recording unit 103. The image data about the work image stored in the image recording unit 103 is transferred to the measurement inspection unit 107 to be used in the measurement and inspection of the work.

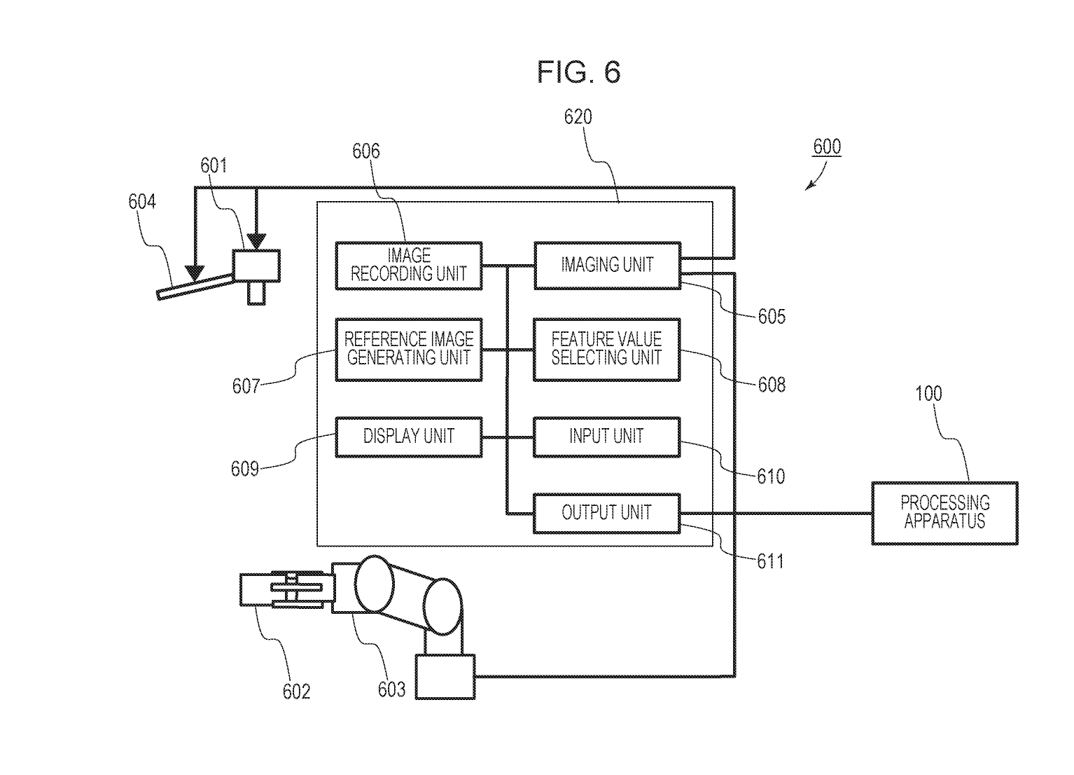

Reference images (templates) generated by a reference image generating apparatus 600 illustrated in FIG. 6 are stored in an input unit 104. The reference images are edge data to be subjected to pattern matching with the captured work image.

The reference selecting unit 105 performs the pattern matching of the work image stored in the image recording unit 103 using the reference images stored in the input unit 104 to select a reference image having the highest matching score, as described below.

The reference registration unit 106 registers the reference image selected by the reference selecting unit 105 and causes the measurement inspection unit 107 to measure and inspect the work exclusively using the reference image registered in the reference registration unit 106 until the model or the painting color of the work is changed.

The measurement inspection unit 107 performs the pattern matching of the work image stored in the image recording unit 103 for each work using the reference image registered in the reference registration unit 106 to measure and inspect the work based on the result of the processing.

An output unit 109 outputs the result of the measurement and inspection in the measurement inspection unit 107. A display unit 108 displays, for example, the selection process of the reference image and the progress of an image forming process.

Referring to FIG. 2, a central processing unit (CPU) 202 in the computer 120 is connected to components including a read only memory (ROM) 203, a random access memory (RAM) 204, a hard disk 205, an interface 206, an input unit 201, the output unit 109, and the display unit 108 via a bus.

The camera 101 captures an image of the work 102 and converts the captured image into digital data about the work image. The image data about the image captured by the camera 101 is supplied to the input unit 201.

The CPU is composed of one or more microprocessors and performs calculation and processing of data. The CPU 202 executes programs stored in the ROM 203, receives data from, for example, the RAM 204, the hard disk 205, or the input unit 201 to perform the calculation and processing of the received data, and supplies the data subjected to the calculation and processing to, for example, the display unit 108, the hard disk 205, or the output unit 109.

The ROM 203 is a memory to read out information that has been written and stores programs and data for a variety of control. The RAM 204 is a memory using a semiconductor device and is used for, for example, temporary storage of data used in the processing in the CPU 202. The hard disk 205 is an external storage unit that stores large-sized data, such as data about the captured image and the reference images (templates).

The interface 206 alternately converts data and various signals to control the camera 101 and the light 110 via a signal line. In addition, the interface 206 communicates with external server, computer, and communication instrument via an optical fiber, a local area network (LAN) cable, and so on.

The display unit 108 generates image signals for a screen on which the processing process is displayed and a screen for operation input to transmit the generated image signals to, for example, an external cathode ray tube (CRT) display, liquid crystal display, or plasma display. The input unit 201 includes a pointing device, such as a keyboard, a touch panel, or a mouse. The output unit 109 is provided with an output terminal for data output.

### (Selection of Reference Image)

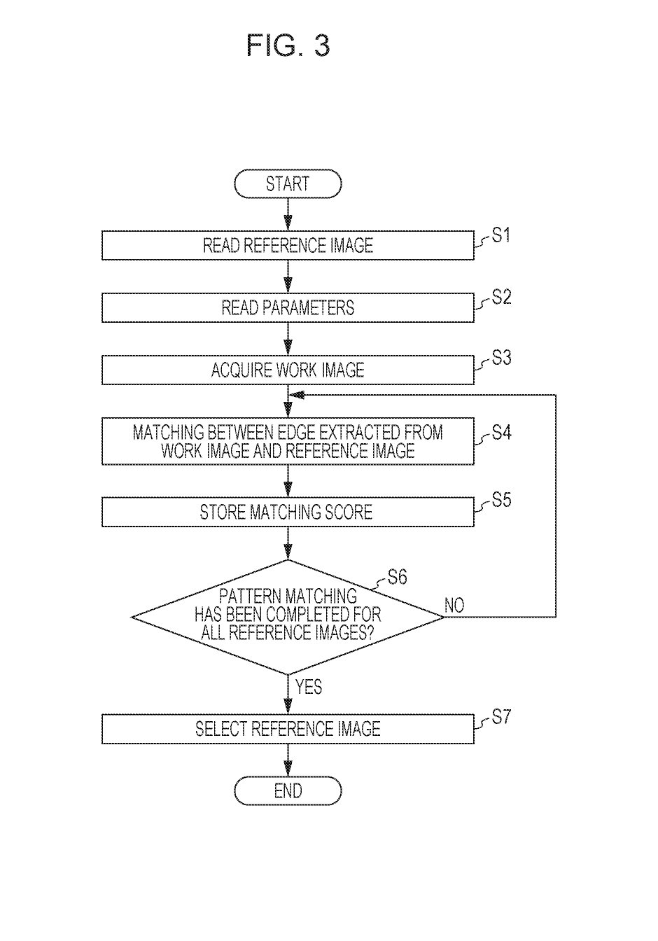

FIG. 3 is a flowchart illustrating an exemplary process of selecting the reference image in the processing apparatus. The flowchart in FIG. 3 will now be described with reference to FIG. 2. Referring to FIG. 3, in Step S1, the CPU 202 reads the reference image from the hard disk 205. In Step S2, the CPU 202 reads parameters used in the pattern matching. The parameters to be read here include a threshold score of the pattern matching, a search angle, a search scale, and a search area.

In Step S3, the CPU 202 acquires the image data about the work image captured with the camera 101 from the hard disk 205. In Step S4, the CPU 202 performs the image processing on the image data about the work image to extract an edge and performs the pattern matching between the extracted edge of the work image and one reference image. In Step S5, the CPU 202 stores the matching score.

In Step S6, the CPU 202 determines whether the pattern matching has been completed for all the reference images. If the CPU 202 determines that the pattern matching has not been completed for all the reference images (NO in Step S6), the process goes back to Step S4. The CPU 202 performs the pattern matching of the extracted edge of the work image by sequentially using all the reference images read out from the hard disk 205 (Step S4) and evaluates the matching score (Step S5). If the CPU 202 determines that the pattern matching has been completed for all the reference images (YES in Step S6), in Step S7, the CPU 202 selects a set of reference images of one scale from the multiple reference images based on the matching score. Specifically, the CPU 202 selects the set of reference images having the highest score from the reference images the matching scores of which exceed a threshold score. A threshold value that prevents false detection is calculated in advance as the threshold score.

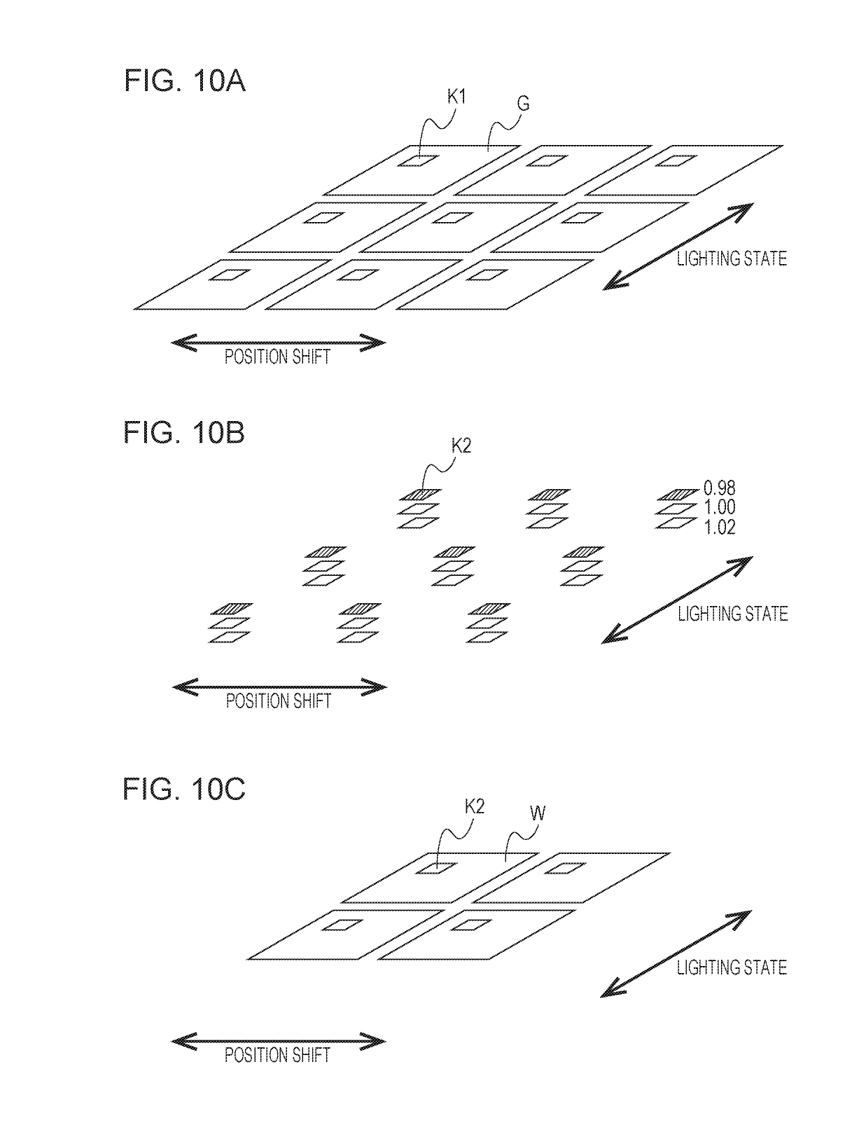

The CPU 202 selects a set of reference images of one scale that is matched with the scale of the work image from the multiple sets of reference images (templates) having different scales in Step S7, as illustrated in FIG. 10B. This absorbs the difference in scale between the reference image generated in the reference image generating apparatus 600 in FIG. 6, which is different from the processing apparatus 100, and the work image captured with the camera 101.

As described above, the hard disk 205, which is an exemplary storage unit, stores the multiple sets of reference images having multiple different scales corresponding to image capturing conditions. The CPU 202 performs an image capturing process and a selection process. In the image capturing process, the CPU 202 captures an image of the work with the camera 101 to acquire the work image.

In the selection process, the CPU 202 captures an image of the work with the camera 101 to acquire the work image and performs the pattern matching between the work image and the multiple reference images to select the set of reference images used in the processing apparatus 100 from the multiple reference images. Specifically, the CPU 202 selects the set of reference images of one scale from the multiple reference images having different scales, which are read out from the hard disk 205.

### (Pattern Matching)

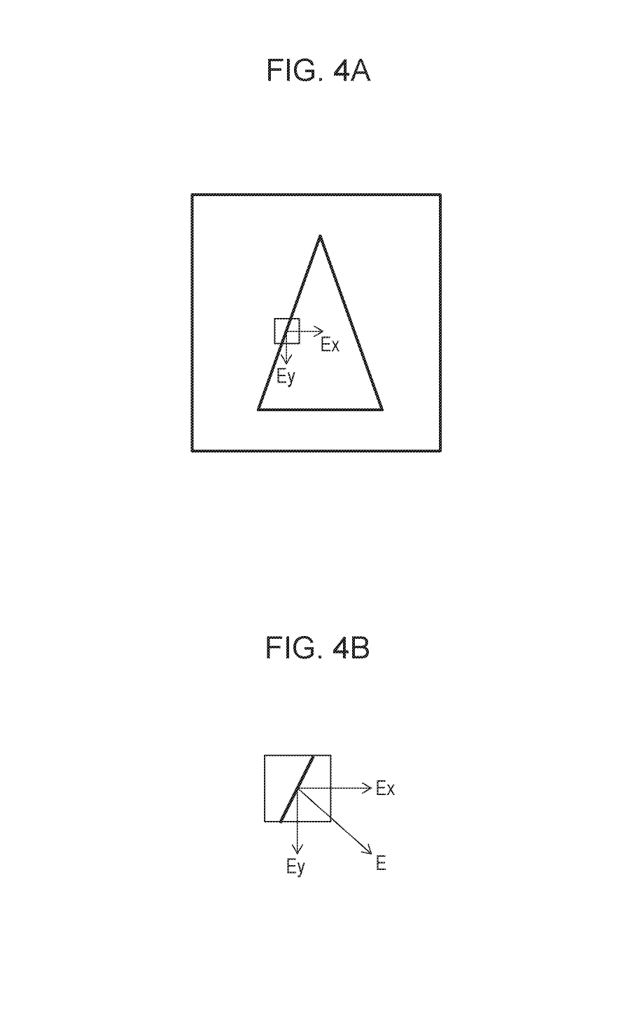

FIGS. 4A and 4B are diagrams for describing a method of extracting an edge from image data. FIG. 4A illustrates image data. FIG. 4B is a diagram for describing the edge strength in one target pixel.

The pattern matching is a process of searching the search area set on the work image for a position having the highest similarity with the reference image (template) that is registered in advance. If the similarity (matching score) between the input image and the reference image at the position that is searched for is higher than the threshold value (threshold score), it is determined that the matching succeeded and the position having the highest score, among the positions that are searched for, is output as the matching position. The pattern matching between an edge image extracted from the work image and the reference image will now be described.

As illustrated in FIG. 4A, among all the pixels in the work image, a pixel with a gradient strength E which is higher than or equal to a predetermined threshold value, that is, an edge is extracted. In the edge extraction, the gradient strengths and the gradient directions of the luminance of all the pixels in the work image are calculated. The gradient strength is calculated using Sobel filters in the x direction and the y direction. An x-axis direction gradient strength Ex and a y-axis direction gradient strength Ey are calculated at each pixel.

As illustrated in FIG. 4B, the final gradient strength E in each image is calculated according to the following equation [1] as a square root of the sum of squares of the x-axis direction gradient strength Ex and the y-axis direction gradient strength Ey:

E=\sqrt{Ex²+Ey}[Formula 1]

A gradient direction θ is calculated according to the following equation [2] using the x-axis direction gradient strength Ex and the y-axis direction gradient strength Ey:

$$θ = {tan}^{- 1} ( \frac{Ey}{Ex} ) \qquad [ Formula 2 ]$$

A pixel having the gradient strength E higher than the predetermined threshold value is selected from all of the pixels in the work image to extract an edge of the work image. Then, the pattern matching between the extracted edge and one reference image to evaluate the reference image. A matching score Sij of reference image at a detection position (i,j) of each pixel is calculated according to the following equation [3] for all the pixels on the image data near the extracted edge:

$${S}_{ij} = \frac{1}{N} {\sum }_{k = 0}^{N - 1} {S}_{k} \qquad [ Formula 3 ]$$

A local score Sk is calculated for each model edge point in a candidate model and is calculated according to the following equation [4]. In the following equation, θTk denotes the gradient direction θ of each edge point of the extracted edge and θMk denotes the gradient direction θ of each edge point of the model edge.

Sₖ=cos(θTk−θMk) [Formula 4]

The local score Sk and the matching score Sij each have a value from −1 to 1. The level of the pattern matching is increased as the value comes closer to one.

### (Work Processing)

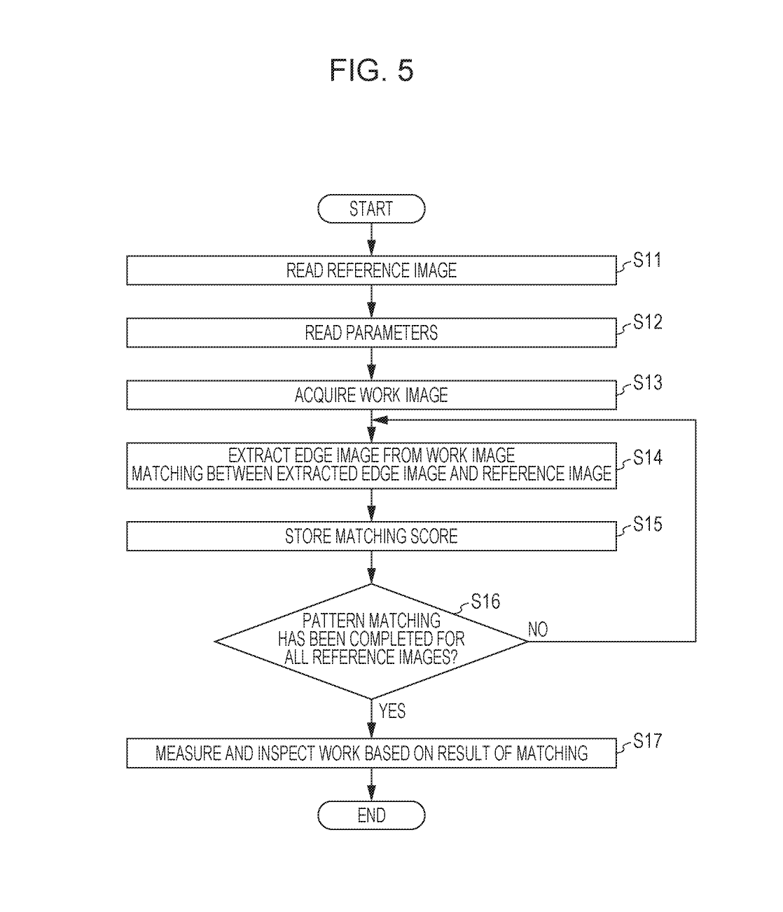

FIG. 5 is a flowchart illustrating an exemplary process of measuring and inspecting the work in the processing apparatus. Referring to FIG. 5, in Step S11, the CPU 202 reads a set of reference images selected for use in the processing of the work from the hard disk 205. The reference image is the edge data. In Step S12, the CPU 202 reads parameters used in the subsequent pattern matching and so on, as described above.

In Step S13, the CPU 202 acquires image data about the work image recorded in the input unit 201. In Step S14, the CPU 202 extracts an edge from the acquired image data about the work image and performs the pattern matching between the edge extracted from the image data about the work image and the reference image. Since the method of extracting the edge from the image data about the work image and the method of performing the pattern matching are the same as those described above, a description of the methods is omitted herein.

In Step 15, the CPU 202 stores the matching score acquired through the pattern matching. In Step S16, the CPU 202 determines whether the pattern matching has been completed for all the reference images. If the CPU 202 determines that the pattern matching has not been completed for all the reference images (NO in Step S16), the process goes back to Step S14. The CPU 202 performs the pattern matching for the image data about the extracted edge (Step S14) and stores the matching score (Step S15) for all the reference images included in the set of reference images of one scale. If the CPU 202 determines that the pattern matching has been completed for all the reference images (YES in Step S16), in Step S17, the CPU 202 selects one reference image from the multiple reference images based on the stored matching score. The CPU 202 selects the reference image having the highest score from the reference images the matching scores of which exceed the threshold score. The threshold value that prevents false detection is calculated in advance as the threshold score.

In Step S17, the CPU 202 performs the measurement and inspection of the work 102 based on the result of the pattern matching. The CPU 202 displays the result of the pattern matching in the display unit 108 and outputs the result of the pattern matching to an external apparatus with the output unit 109.

As described above, in the processing process performed by the CPU 202, the pattern matching of the work image acquired with the camera 101 is performed using the reference image selected in the selection process and processes the work based on the result of the pattern matching. The CPU 202 processes the work using the work image acquired in the image capturing process and the set of reference images selected in the selection process.

### COMPARATIVE EXAMPLE

Cameras (visual sensors) are used in a factory automation (FA) field in order to optically measure the presence of works, the positions and orientations of the works, and so on or in order to check failures occurring in the works, coating materials that are applied, and so on.

As a typical exemplary method of performing measurement, inspection, and positioning of a work, a method of performing the pattern matching between an image captured with a camera and a reference image (template) that is prepared in advance is known.

Development operation of a typical manufacturing apparatus includes three processes: a design process, a fabrication process, and a test operation process. After the manufacturing apparatus is assembled in the fabrication process, an original image is captured with a work being actually held in the manufacturing apparatus in the test operation process to generate a reference image used in the pattern matching in the manufacturing apparatus. However, at a production site in which the manufacturing apparatus is used, the position where an image of the work is captured may be shifted or the lighting state of the work may be changed. When such a disturbance occurs, the matching score at the position having the highest similarity between the work image and the reference image (template) does not reach the threshold value, a matching error is output, and the manufacturing apparatus is forcibly stopped.

Accordingly, in the manufacturing apparatus, it is necessary to use the reference image with which the pattern matching is capable of being stably performed even if such a disturbance occurs. When the edge image of the work is selected from the original image captured with the camera to generate the reference image, the robustness of the pattern matching greatly depends on which edge of the work is selected.

For this reason, it is necessary for an experienced engineer to generate the reference image through trial and error. In order to generate the versatile reference image, it is necessary to capture many work images having different image capturing conditions provided through trial and error. Accordingly, it takes a lot of time to capture the work images.

In the above situation, in a comparative example, as illustrated in FIG. 1, multiple kinds of lighting effects and gradient effects are added to only one original image captured with the camera 101 in the processing apparatus 100 through simulation image processing to artificially generate the work images having different image capturing conditions. The multiple kinds of work images artificially generated are subjected to the image processing to generate the reference image sets each including the multiple reference images and the generated reference image sets are stored in the input unit 104.

In the comparative example, the pattern matching of the work image that is captured is performed by sequentially using the reference images included in the set of reference images of one scale, which is stored in the input unit 104. The reference image having the highest matching score is selected to support the variation in the light, the gradient, and so on. This reduces the number of times of the image capturing of the work images at the production site to reduce the downtime of the processing apparatus 100, which is caused by the generation of the reference image. In the comparative example, the work images with high accuracy are capable of being reproduced through the simulation image processing in a simple difference in the scale and a slight variation in the lighting state.

However, in the comparative example, it is difficult to reproduce a slight variation in the holding state and the lighting state of the work image, which is caused by the gradients in Rx direction, Ry direction, and Rz direction (hereinafter referred to as a tilt direction) of the work relative to the optical axis direction of the camera. The gradients incidentally occur in the processing apparatus 100. Since it is difficult to generate the reference image corresponding to the work image subjected to such a variation, false recognition and erroneous measurement may incidentally occur in the comparative example.

In addition, in the comparative example, since the pattern matching of the work image with all the many reference images that are prepared in advance is performed, the number of times of the pattern matching necessary for the operation of the processing apparatus is increased with the increasing kinds of the image capturing conditions and the increasing variation width. As a result, the total processing time necessary for the measurement and inspection of the work at the production site is increased.

In order to resolve the above issues, in the first embodiment, as illustrated in FIG. 6, the reference image generating apparatus 600 is provided outside the production site to allow a large amount of reference images having different image capturing conditions to be efficiently generated in a short time. At the production site, the original images generated in the reference image generating apparatus 600 are downloaded to the processing apparatus 100 for storage and a reference image optimal for the image capturing condition is selected from the stored images in a short time. As described above, the processing apparatus 100 determines an optimal reference image from the stored reference images and performs the measurement and inspection of the work using the optimal reference image.

### (Reference Image Generating Apparatus)

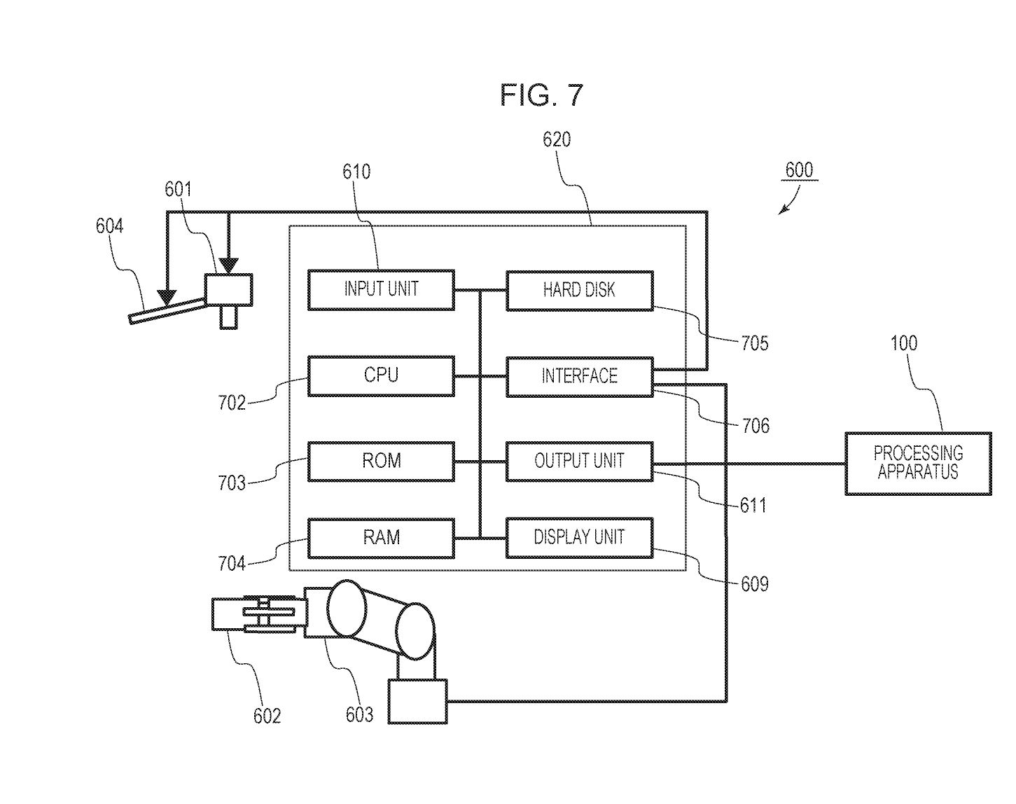

FIG. 6 is an exemplary functional block diagram of the reference image generating apparatus 600. FIG. 7 is a block diagram illustrating an exemplary hardware configuration of the reference image generating apparatus 600.

As illustrated in FIG. 6, the reference image generating apparatus 600 generates the reference image from the original image of a work 602 captured with a camera 601. The work 602 is the same as the work 102 illustrated in FIG. 1.

The reference image generating apparatus 600 includes the camera 601, a light 604, a robot arm 603, a computer 620, and so on. An image recording unit 606, an imaging unit 605, a reference image generating unit 607, and a feature value selecting unit 608 are virtually realized as programs executed by the computer 620.

The camera 601 captures an image of the work 602 and converts the captured image into digital data. The light 604 is a light emitting diode (LED) light and is capable of being adjusted to an arbitrary brightness. The robot arm 603 holds the work 602 to place the work 602 at an arbitrary position and an arbitrary orientation.

The robot arm 603 and the light 604, which are examples of a setting unit, are capable of varying and setting the image capturing condition of the work. The light 604, which is an exemplary work light, is capable of adjusting the lighting state of the work when an image of the work is captured with the camera 601. The robot arm 603, which is an exemplary work holding unit, is composed of an articulated robot arm and is capable of adjusting a holding state of the work when an image of the work is captured with the camera 601.

The computer 620, which is an exemplary imaging control unit, sets multiple kinds of image capturing conditions for the work 602 with the robot arm 603 and the light 604 in the image capturing process and captures an image of the work 602 with the camera 601 to acquire the original images corresponding to the respective image capturing conditions. The computer 620 captures images of the work 602 with the camera 601 using multiple combinations of the image capturing conditions. Multiple different lighting states of the work, which are set with the light 604, and multiple different holding states of the work, which are set with the robot arm 603, are used to set the multiple combinations of the image capturing conditions.

The imaging unit 605 varies the lighting state of the work 602 with the light 604. The adjustment width of the light 604 may be set to a range slightly wider than a variation range of the lighting state which may occur at the site in consideration of, for example, reduction in luminance of the light 604 caused by long term use, variation in ambient light, and sudden incidence of light. For example, when the reduction in luminance during the life of the light 604 is 20% or less, the brightness of the light 604 is varied within a range from 80% to 110%. The number of steps of the brightness is based on three levels: a maximum value, a median, and a minimum value. However, when the total number of the original images is not so large, the number of steps of the brightness may be set to four or more.

The imaging unit 605 varies the holding state of the work 602 with the robot arm 603. The range of position shifts of the robot arm 603 is slightly wider than the range within which the work 602 may be shifted from an imaging origin in the processing apparatus 100 illustrated in FIG. 1. For example, when the robot arm 603 is possibly shifted with respect to the optical axis of the camera 601 by ±5 mm in the X, Y, and Z directions and by ±2° around the Rx, Ry, and Rz directions, the range of the position shift is set to ±6 mm in the X, Y, and Z directions and by ±2.4° around the Rx, Ry, and Rz directions. The number of steps of the position shift is based on three levels: a maximum value, a median, and a minimum value with respect to the amount of variation around each axis. However, when the number of parameters to be varied is small and the total number of the original images is not so large, the number of steps of the position shift may be set to four or more.

Referring to FIG. 7, a CPU 702 in the computer 620 is connected to components including a ROM 703, a RAM 704, a hard disk 705, an interface 706, an input unit 610, an output unit 611, and a display unit 609 via a bus.

Image data about an image captured with the camera 601 is supplied to the input unit 610. The camera 601 captures an image of the work 602 and converts the captured image into digital data about the original image.

The CPU 702 is composed of one or more microprocessors and performs calculation and processing of data. The CPU 702 executes programs stored in the ROM 703, receives data from, for example, the RAM 704, the hard disk 705, or the input unit 610 to perform the calculation and processing of the received data, and supplies the data subjected to the calculation and processing to, for example, the display unit 609, the hard disk 705, or the output unit 611.

The ROM 703 is a memory to read out information that has been written and stores programs and data for a variety of control. The RAM 704 is a memory using a semiconductor device and is used for, for example, temporary storage of data used in the processing in the CPU 702. The hard disk 705 is an external storage unit that stores a large amount of data.

The interface 706 alternately converts data and various signals to control the camera 601 and the light 604 via a signal line. In addition, the interface 706 communicates with external server, computer, and communication instrument via an optical fiber, a LAN cable, and so on.

The display unit 609 is, for example, a CRT display, a liquid crystal display, or a plasma display. The input unit 610 includes a pointing device, such as a keyboard, a touch panel, or a mouse. The output unit 611 is provided with an output terminal for output of data to the processing apparatus 100.

### (Capturing Original Image)

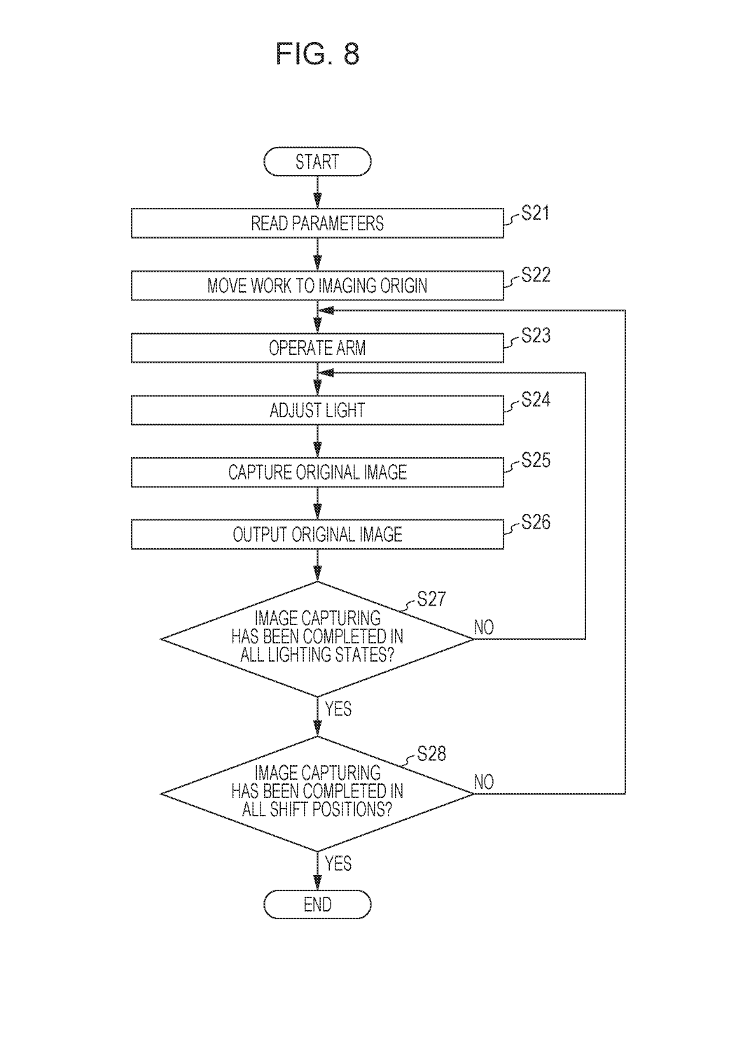

FIG. 8 is a flowchart illustrating an exemplary process of capturing the original image. The flowchart in FIG. 8 will now be described with reference to FIG. 7. Referring to FIG. 8, in Step S21, the CPU 702 reads parameters used in the subsequent pattern matching, as described above.

In Step S22, the CPU 702 operates the robot arm 603 to move the work 602 to the imaging origin. The imaging origin is a position in a state in which the work 602 is positioned at the same image capturing positions and the same orientation as those of the work 102 in the processing apparatus 100 illustrated in FIG. 1 with respect to the camera 601. The CPU 702 sets multiple image capturing conditions defined by combinations of multiple lighting states and multiple shift positions before starting the image capturing.

In Step S23, the CPU 702 operates the robot arm 603 to move the work 602 to one of the shift positions described above. In Step S24, the CPU 702 adjusts the light 604 to set one of the lighting states described above for the work 602. In Step S25, the CPU 702 operates the camera 601 to capture the original image corresponding to each image capturing condition.

In Step S26, the CPU 702 outputs the image data about the original image corresponding to each image capturing condition. In the output of the image data, the CPU 702 concurrently outputs which variation in the image capturing condition is set in the image capturing as additional information on the image data. The additional information may be described in a file of the image data, may be incorporated in the image data, or may be included in an image name.

In Step S27, the CPU 702 determines whether the image capturing has been completed in all the lighting states. If the CPU 702 determines that the image capturing has not been completed in all the lighting states (NO in Step S27), the process goes back to Step S24. The imaging unit 605 sequentially sets the remaining lighting states in a programmed order (Step S24) and efficiently performs the image capturing without any omission (Step S25). The CPU 702 outputs the image data about the captured original image (Step S26).

If the CPU 702 determines that the image capturing has been completed in all the lighting states (YES in Step S27), in Step S28, the CPU 702 determines whether the image capturing has been completed in all the shift positions. If the CPU 702 determines that the image capturing has not been completed in all the shift positions (NO in Step S28), the process goes back to Step S23. The imaging unit 605 sequentially sets the remaining shift positions in a programmed order (Step S24) and efficiently performs the image capturing at each shift position without any omission (Step S25). The CPU 702 outputs the image data about the captured original image (Step S26).

If the CPU 702 determines that the image capturing has been completed in all the shift positions (YES in Step S28), the process of capturing the original image illustrated in FIG. 8 is terminated.

### (Image Processing of Original Image)

As illustrated in FIG. 6, the image recording unit 606 records the image data about the original images corresponding to the respective image capturing conditions, which are captured by the imaging unit 605. The image data about the original images corresponding to the respective image capturing conditions, which is recorded in the image recording unit 606, is supplied to the feature value selecting unit 608. The feature value selecting unit 608 extracts a featuring edge image from the image data about the original images recorded in the image recording unit 606 and selects an edge available as the reference image from the edge image.

The reference image generating unit 607 varies the scale of the reference image in a first step of each image capturing condition, which is generated by the feature value selecting unit 608, to generate the reference images in a second step having multiple scales. The output unit 611 transmits the set of reference images generated by the reference image generating unit 607 to the processing apparatus 100.

The display unit 609 displays the selection process of the reference image, the progress of the image forming process, the matching score involved in the pattern matching, and so on. The input unit 610 is capable of inputting the image data about the original image of the work 602, which is received from the processing apparatus 100 or received via a non-transitory computer readable recording medium or a network server, in addition to the input of the image data about the original image of the work 602 with the camera 601. The image data about the original image input with the input unit 610 is supplied to the feature value selecting unit 608. The feature value selecting unit 608 may extract an edge image from the image data about the original images, other than the image data recorded in the image recording unit 606, and may select an edge available as the reference image from the edge image.

### (Process of Selecting Feature Value)

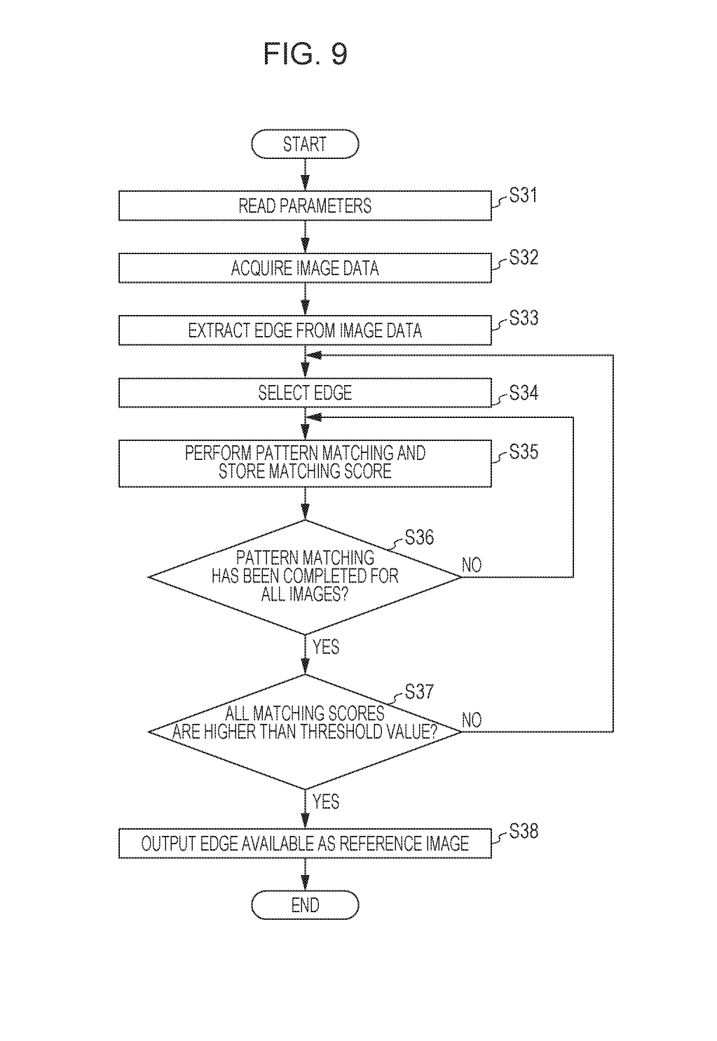

FIG. 9 is a flowchart illustrating an exemplary process of selecting a feature value. Referring to FIG. 9, in Step S31, the CPU 702 reads parameters used in the subsequent pattern matching. In Step S32, the CPU 702 acquires the image data about the original image from the hard disk 705.

In Step S33, the CPU 702 extracts an edge image from the acquired image data about the original image. The CPU 702 sets a condition for extracting an edge from the image to extract an edge from one original image. The CPU 702 performs the pattern matching of another original image using the extracted edge to calculate the matching score and modifies the condition for extracting an edge from the image so that the matching scores of the pattern matching between the extracted edge and all the original images meet a predetermined criterion. Since the method of extracting the edge image from the image data about the original image is the same as the method of extracting the edge image from the work image described above, a description of the method of extracting the edge image from the image data about the original image is omitted herein.

In Step S34, the CPU 702 displays candidates for the extracted edge image in the display unit 609 to cause the operator to select an edge available as the reference image on the edge image. The CPU 702 displays the multiple candidates for the reference image, generated through the image processing of the original image, in the display unit 609 so as to be selected by a user. The CPU 702 displays the candidates for the reference image in the display unit 609 so as to be edited by the user. The experienced operator performs the image processing and the edge selection while viewing the edge image displayed on the image in the display unit 609 to enable the edge image having a high robustness to the varied elements described above to be generated.

Upon selection of an edge that is needed by the operator on the edge image of the original image displayed in the display unit 609, in Step S35, the CPU 702 performs the pattern matching of the original image acquired from the hard disk 705 using the selected edge image. The CPU 702 calculates the matching score and stores the calculated matching score if the pattern matching succeeded.

In Step S36, the CPU 702 determines whether the matching scores have been stored for all the original images of the same work, which have the different image capturing conditions. If the CPU 702 determines that the matching scores have not been stored for all the original images of the same work, which have the different image capturing conditions (NO in Step S36), the process goes back to Step S35. The CPU 702 acquires the next original image having a different image capturing condition from the hard disk 705 and performs the pattern matching to the acquired original image (Step S35).

If the CPU 702 determines that the matching scores have been stored for all the original images of the same work, which have the different image capturing conditions (YES in Step S36), in Step S37, the CPU 702 compares all the stored matching scores with a threshold value to determine whether all the matching scores are higher than the threshold value.

If the CPU 702 determines that the original image having the matching score lower than the threshold value remains (NO in Step S37), the process goes back to Step S34. The CPU 702 displays the fact that “the selection of the edge image is inappropriate” and “the extracted edge image” in the display unit 609 again to prompt the operator to select an edge again (Step S34).

If the CPU 702 determines that the matching scores of all the original images are higher than the threshold value (YES in Step S37), in Step S38, the CPU 702 displays the selected edge image in the display unit 609 and records the edge image in the output unit 611.

Repetition of the above steps (Step S31 to Step S38) for the image data about the original images corresponding to all the image capturing conditions recorded in the image recording unit 606 selects the reference image composed of the edge image having high robustness to the variation in the image capturing condition.

### (Variation in Scale)

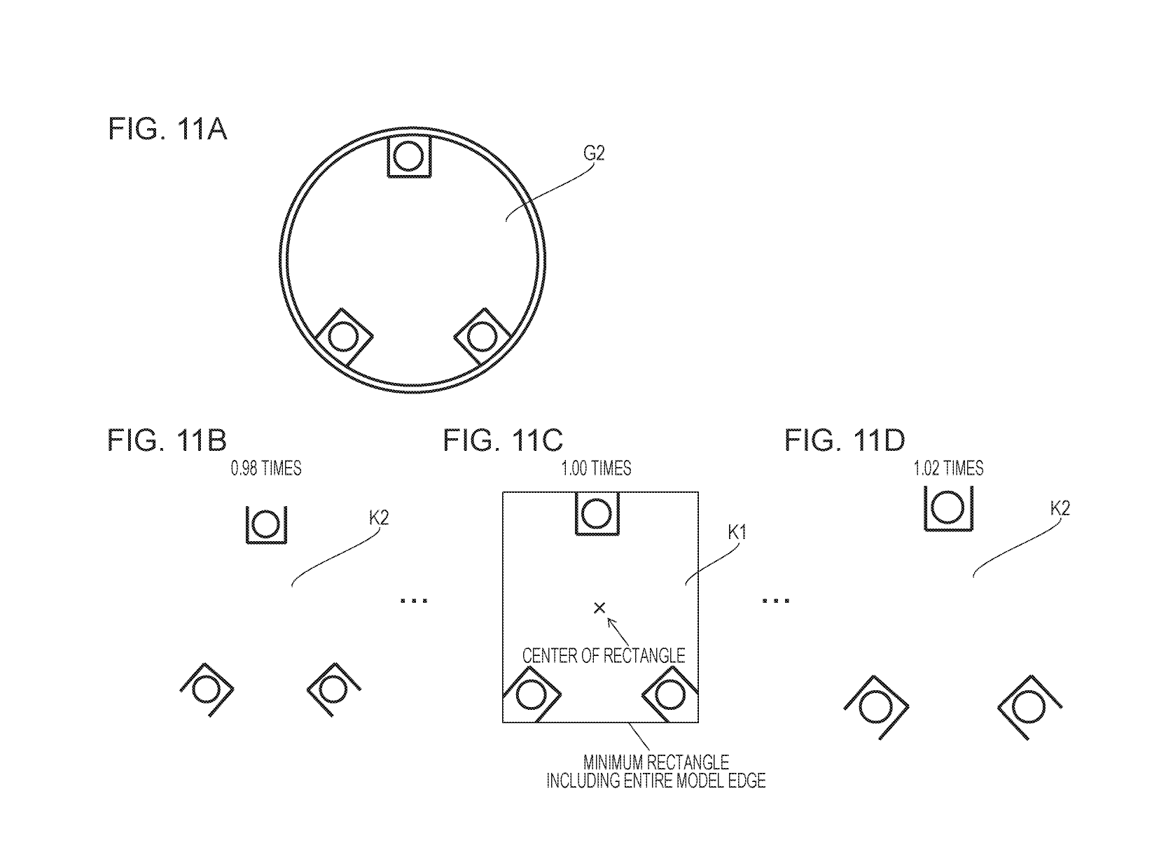

FIGS. 10A to 10C are diagrams for describing the sets of reference images. FIGS. 11A to 11D are diagrams for describing the scales of the reference image. FIG. 11A illustrates an edge extracted from an original image. FIG. 11B illustrates a reduced reference image that is 0.98 times the edge image. FIG. 11C illustrates a reference image that is 1.00 times the edge image. FIG. 11D illustrates an enlarged reference image that is 1.02 times the edge image.

The reference image generating apparatus 600, which is an exemplary generation apparatus, acquires many original images G having different shift positions and different lighting states, as illustrated in FIG. 10A, and performs the image processing on the original images G to generate a reference image K1 corresponding to each image capturing condition. Although the three position shifts are exemplified, the actual number of the position shifts is 72. Three (the number of the x, y, and z directions) multiplied by three makes nine and nine multiplied by two to the third power (the rotations around the Rx, Ry, and Rz directions) is 72 (3×3×2×2×2=72).

The reference image generating apparatus 600 performs the image processing on the original images G acquired through the image capturing of the work 602 with the camera 601 to generate reference images K2 used in the pattern matching. However, the camera 601, which is an exemplary first camera, is different from the camera 101, which is an exemplary second camera. Accordingly, the pattern matching between the reference image generated from the original image captured with the camera 601 and the work image captured with the camera 101 causes a reduction in the matching score based on the difference in scale between the original image and the work image. The reduction in the matching score may reduce the accuracy of the pattern matching or may disable the pattern matching.

Accordingly, in the first embodiment, as illustrated in FIG. 11B, FIG. 11C, and FIG. 11D, the set of the n-number reference images K2 having different n-number scales are prepared. Specifically, the reference image generating apparatus 600 generates, for example, the sets of the three reference images K2 resulting from varying the scale of the reference image K1 in three levels, as illustrated in FIG. 10B.

The processing apparatus 100 selects a set of the reference images K2 of one scale matched with the scale of a work image W from the n-number reference images K2, as illustrated in FIG. 10C. The processing apparatus 100 acquires the work image W within a position shift range and a lighting state range narrower than those of the original image G, performs the pattern matching using one set of the reference images K2, and performs measurement and inspection of the work 602 based on the result of the processing.

The processing apparatus 100 selects a set of the reference images K2 of the scale at which the highest matching score is achieved, as illustrated in FIG. 11C, and performs the pattern matching between the work image W and the selected set of the reference images K2. The processing apparatus 100 performs the measurement and inspection of the work 602, including the pattern matching, using the set of reference images including the reference image having the highest matching score, among the sets of the n-number reference images having different scales.

The reference image K1 in the first step is an edge image G2 appropriately selected through the image processing of the original image G. The reference image generating unit 607 enlarges and reduces the reference image K1 in the first step at multiple scales to generate the reference images K2 in the second step.

The feature value selecting unit 608 transfers one edge image G2 illustrated in FIG. 11A to the reference image generating unit 607. The reference image generating unit 607 creates a minimum rectangle including the entire range of the reference image K1 in the edge image G2, as illustrated in FIG. 11C. The reference image generating unit 607 varies the image scale using the central position of the minimum rectangle as the origin of the enlargement and reduction to generate the n-number reference images K2 in the second step, as illustrated in FIG. 11B and FIG. 11D.

The enlargement and reduction scale width is calculated from the work distance (WD) of the camera and the difference in the point of focus between the individual cameras. For example, when the WD of the camera is 600 mm and the difference in the point of focus between the individual camera is ±6 mm, the scale range of enlargement and reduction is set to 0.98 times to 1.02 times so as to support the greatest difference between the two cameras to generate the reference images K2.

When a factor causing the difference, other than the difference between the individual cameras, exists, the scale range of enlargement and reduction is converted into a scale range of enlargement and reduction taking the factor causing the difference, other than the difference between the individual cameras, into consideration. The factor causing the difference is, for example, the shift of the positions where the cameras are placed. The step size of the enlargement and reduction is an arbitrary width. The step size may be set by the user or may be determined from the usage of the memory or the processing speed.

### (Process of Generating Reference Image Set)

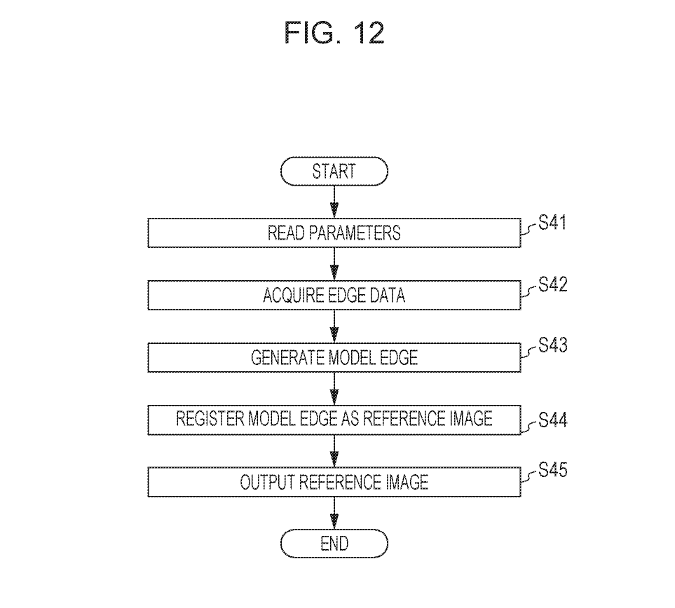

FIG. 12 is a flowchart illustrating an exemplary process of generating the reference image. The flowchart in FIG. 12 will now be described with reference to FIG. 7. Referring to FIG. 12, in Step S41, the CPU 702 reads parameters used in the subsequent pattern matching.

In Step S42, the CPU 702 reads the reference image corresponding to each image capturing condition from the hard disk 705. In Step S43, the CPU 702 performs the enlargement and reduction at multiple scales to one reference image in the first step, which is read, to generate multiple reference images in the second step.

In Step S44, the CPU 702 registers the reference images having the same scale and different image capturing conditions as a set of reference images. In Step S45, the CPU 702 supplies the registered set of reference images to the processing apparatus 100. The set of reference images output from the reference image generating apparatus 600 is downloaded into the processing apparatus 100.

As described above, the computer 620, which is an exemplary image processing unit, performs a second image processing process after a first image processing process and performs the image processing on the original images corresponding to the respective image capturing conditions to generate the reference images in multiple steps. In the first image processing process, the computer 620 performs the image processing on the original images of multiple kinds corresponding to the image capturing conditions of multiple kinds acquired in the image capturing process to generate the reference images corresponding to the respective image capturing conditions. In the second image processing process, the computer 620 generates the sets of reference images having multiple different scales for the respective original images corresponding to the respective image capturing conditions. The difference in scale between the different scales is 5% or less.

Setting the difference between the maximum scale and the minimum scale to 5% means that 50%, 25%, and 200% are not included as the difference in scale. This setting is used to exclude known technologies to reduce the amount of calculation in the pattern matching by switching from the reference images at a low scale to the reference images at a high scale.

### Advantages of First Embodiment

In the first embodiment, the measurement and inspection of the work are capable of being performed in the processing apparatus 100 using the groups of reference images generated by the reference image generating apparatus 600, which is provided separately from the processing apparatus 100 at the site. Accordingly, the amount of the operation to generate the reference images at the site is greatly reduced and it is not necessary for the rather experienced operator to go to the site at which the processing apparatus 100 is installed for the generation of the reference images. If an issue involved in the reference images occur in the processing apparatus 100, the reference image generating apparatus 600 is capable of reproducing the issue that has occurred in the processing apparatus 100 to review the reference images, taking a new original image, and generating new reference images with the reference image generating unit 607. Since the processing apparatus 100 is capable of operating continuously within a range that does not cause an issue during the operation of the reference image generating apparatus 600, it is possible to minimize the stop of the processing apparatus 100 involved in the setting of the reference images to improve the operating ratio of the processing apparatus 100.

In the first embodiment, it is possible to accurately evaluate the variation in lighting, the variation in angle, and so on, which incidentally occur in the processing apparatus 100 at the site and which are difficult to occur constantly in the generation of the reference images in the processing apparatus 100, in the image capturing of the work 602 with the camera 601 to reflect the result of the evaluation in the reference images.

In the first embodiment, the processing apparatus 100 at the site is capable of evaluating in advance a sudden variation in the image capturing environment and so on, which are difficult to occur intentionally, to generate the reference images having high robustness. It is possible to generate the reference images having high robustness, which are capable of supporting the variation which incidentally occurs at the production site and the constant reproduction of which at the site is difficult in the generation of the model, for example, the variation in the image in the tilt direction. Since the reference images having high robustness are capable of being generated quickly, false detection of the work is reduced to improve the accuracy of the measurement and inspection.

In the first embodiment, the difference in the reference images caused by the generation of the reference images by the reference image generating apparatus 600 provided separately from the processing apparatus 100 is absorbed using the reference images at the three-level scales. Accordingly, the operator is capable of concurrently performing the design process and the generation of the reference images. As a result, the time period from the design of the apparatus to the completion of the test operation is reduced.

Since the reference image is automatically selected from the reference images which have high robustness and which have been generated in the first embodiment, the number of times of the matching process performed at the production site is decreased to speed up the processing and improve the operating ratio of the apparatus.

### OTHER EMBODIMENTS

While the invention is described in terms of some specific examples and embodiments, it will be clear that this invention is not limited to these specific examples and embodiments and that many changes and modified embodiments will be obvious to those skilled in the art without departing from the true spirit and scope of the invention.

The reference image selected by the reference selecting unit 105 is directly used in the measurement inspection unit 107 in the first embodiment. However, the reference image resulting from horizontal and/or vertical enlargement or reduction of the selected reference image may be used in the measurement inspection unit 107 as the reference image.

Although the pattern matching is performed in units of pixels in the first embodiment, the first embodiment is not limited to this. The pattern matching may be performed in units of sub-pixels when an increase in the accuracy is needed.

Although the matching score of one kind is calculated at one detection position in the pattern matching in the first embodiment, the pattern matching is not limited to this. The score of each angle of the reference image may be stored for one detection position.

Although the reference image is based on the edge image in the first embodiment, an image other than the edge image may be used in the pattern matching. For example, the matching area may be determined in the same manner also in normalized correlation matching.

Although the reference images having different scales are generated in the reference image generating apparatus in order to absorb the difference between the processing apparatus and the reference image generating apparatus in the first embodiment, the generation of the multiple reference images may be performed in the processing apparatus.

Only the enlargement and reduction are used as the varied elements for absorbing the difference between the reference image generating apparatus and the processing apparatus in consideration of the difference in distance between the camera and the work and the difference in focal point between lenses in the first embodiment. However, rotation elements may be added to the varied elements in consideration of the accuracy of the position where the camera is mounted.

Although the operator selects the reference image while viewing the edge image displayed on the screen in the generation of the reference image in the first embodiment, only the edge image common to the edge of a three-dimensional model of the work may be displayed in the display unit 609. The selection and editing of the edge of the reference image may be automatically performed by an image processing program in the computer 620, instead of the operator.

Although the generation of the reference image is performed using the edge image extracted from the original image in the first embodiment, the generation of the reference image is not limited to this. The reference image may be generated using an image resulting from simulation thorough filtering, noise insertion, or luminance conversion of the original image.

Although the original image is captured while the light 604 is fixed and only the brightness of the light is varied in the first embodiment, the capturing of the original image is not limited to this. A movable light may be used as the light 604 or multiple lights 604 may be used to enable setting of the variation in brightness from various directions. A spotlight or the like may be used.

Although the reference image having the highest matching score in the pattern matching is selected from the reference images the matching scores of which exceed the threshold score in the first embodiment, the selection of the reference image is not limited to this. For example, multiple reference images having higher matching scores may be selected. Alternatively, multiple reference images having higher matching scores may be displayed to cause the operator to select a reference image.

Although the robot arm 603 is capable of holding the work 602 at arbitrary position and orientation under the control of the computer 620 in the first embodiment, the holding of the work 602 is not limited to the robot arm 603. For example, a six-axis stage in which automatic stages are combined may be used as long as the stage is capable of holding the work 602 at arbitrary position and orientation.

In the first embodiment, the image capturing scale of the original image may be varied with the camera 601 and the image processing may be performed using the image capturing scale to generate the sets of reference images having different scales.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions. Embodiments may be realized by a processor, computer, or apparatus that reads out and executes computer executable instructions recorded onto a recording medium (e.g., non-transitory computer-readable recording medium, non-transitory computer-readable storage medium, and storage medium) to perform the functions of one or more of the above-described embodiment(s) or unit(s). The computer may comprise one or more of a central processing unit (CPU), micro processing unit (MPU), application specific integrated circuit (ASIC), digital signal processor (DSP), floating processor gate array (FPGA), or other circuitry, and may include a network of separate computers or separate processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like. The instructions for performing the method may be received over a network connection and executed by one or more processors.

This application claims the benefit of Japanese Patent Application No. 2015-165595, filed Aug. 25, 2015 which is hereby incorporated by reference herein in its entirety.

What is claimed is:

1. An image processing method comprising:
generating a plurality of reference images by capturing an image of an object with a first camera to acquire an original image and performing image processing on the acquired original image in a reference image generating apparatus including the first camera;
selecting a reference image used in an object processing apparatus from the plurality of reference images by capturing an image of the object with a second camera to acquire an object image and performing pattern matching between the acquired object image and the plurality of reference images that are generated in the object processing apparatus including the second camera; and
performing the pattern matching between the reference image selected in the object processing apparatus and the acquired object image.

2. A reference image generating method of generating a reference image to be subjected to pattern matching with an object image acquired by capturing an image of an object with a second camera different from a first camera using a reference image generating apparatus including the first camera and a control unit, the reference image generating method comprising:
capturing an image of the object with the first camera to acquire an original image by the control unit; and
generating a plurality of reference images by performing image processing of the acquired original image by the control unit.

3. The reference image generating method according to claim 2,
wherein the reference image generating apparatus further includes a setting unit capable of varying and setting an image capturing condition of the object,
wherein the control unit acquires the original image by setting multiple kinds of image capturing conditions for the object with the setting unit and capturing an image of the object with the first camera in the multiple kinds of image capturing conditions, and
wherein the control unit generates the plurality of reference images having multiple different scales the difference between which is 5% or less from the acquired original images corresponding to the respective image capturing conditions.

4. The reference image generating method according to claim 3,
wherein the generating includes:
a first image processing step of performing the image processing on the original images corresponding to the respective image capturing conditions to generate the reference images corresponding to the respective image capturing conditions; and
a second image processing step of enlarging or reducing the generated reference images corresponding to the respective image capturing conditions to generate the plurality of reference images.

5. A non-transitory computer readable recording medium recording a program causing a computer to perform the reference image generating method according to claim 2.

6. An image processing method for an object in an object processing apparatus including a storage unit that stores the plurality of reference images which have been generated with the reference image generating method according to claim 3, which have the multiple different scales, and which correspond to the respective image capturing conditions, the second camera, and a control unit, the image processing method comprising:
capturing an image of an object with the second camera to acquire an object image by the control unit;
selecting a set of reference images of one scale, which have the different image capturing conditions, from the reference images stored the storage unit by the control unit; and
processing the object using the acquired object image and the selected set of reference images by the control unit.

7. A non-transitory computer readable recording medium storing a program causing a computer to perform the image processing method for an object according to claim 6.

8. A reference image generating apparatus comprising:
a first camera; and
a setting unit capable of varying and setting an image capturing condition of an object,
wherein the reference image generating apparatus generates a reference image used in pattern matching of an object image acquired by capturing an image of the object with a second camera different from the first camera, the reference image generating apparatus further comprising:
a control unit configured to perform an imaging control step of setting multiple kinds of image capturing conditions for the object with the setting unit and capturing an image of the object with the first camera to acquire original images corresponding to the respective image capturing conditions and an image processing step of performing image processing on the original images corresponding to the respective image capturing conditions acquired in the imaging control step to generate a plurality of reference images.

9. The reference image generating apparatus according to claim 8,
wherein the setting unit includes an object light capable of adjusting a lighting state of the object in the capturing of an image of the object with the first camera, and
wherein the control unit captures an image of the object in the respective image capturing conditions in which the lighting state of the object is varied in multiple steps with the object light in the imaging control step.

10. The reference image generating apparatus according to claim 8,
wherein the setting unit includes an object holder capable of adjusting a holding state of the object in the capturing of an image of the object with the first camera, and
wherein the control unit captures an image of the object in the respective image capturing conditions in which the holding state of the object is varied in multiple steps with the object holder in the imaging control step.

11. The reference image generating apparatus according to claim 10,
wherein the object holder is an articulated robot arm.

12. The reference image generating apparatus according to claim 8, further comprising:
a display unit configured to display an image,
wherein the control unit displays multiple candidates for the reference image generated through the image processing of the original images in the display unit so as to be selected by a user in the image processing step.

13. The reference image generating apparatus according to claim 8, further comprising:
a display unit configured to display an image,
wherein the control unit displays multiple candidates for the reference image generated through the image processing of the original images in the display unit so as to be edited by a user in the image processing step.

14. The reference image generating apparatus according to claim 8,
wherein the control unit sets a condition for extracting an edge from the image to extract an edge from one original image, performs the pattern matching between the extracted edge and another original image to calculate a matching score, and modifies the condition for extracting an edge so that the matching scores of the pattern matching between the extracted edge and all the original images meet a predetermined criterion in the image processing step.

15. The reference image generating apparatus according to claim 8,
wherein the control unit generates the reference images having multiple different scales the difference between which is 5% or less for each of the original images corresponding to the respective image capturing conditions in the image processing step.

16. An apparatus comprising:
a storage unit configured to store the plurality of reference images which have been generated by the reference image generating apparatus according to claim 15, which have the multiple different scales, and which correspond to the respective image capturing conditions;
a second camera; and
a control unit configured to perform an image capturing step of capturing an image of an object with the second camera to acquire an object image, a selecting step of selecting a set of reference images of one scale, which have different image capturing conditions, from the reference images stored the storage unit, and a processing step of processing the object using the acquired object image and the selected set of reference images.
